(19) United States
(12) Patent Application Publication
(10) Pub. No.: US 2024/0319023 A1
(43) Pub. Date: Sep. 26, 2024

(54) Ion gradient power-generation stretching strain sensor and its preparation method

(71) Applicant: University Electronic Science and Technology of China, Chengdu (CN)

(72) Inventors: Zaihua Duan, Chengdu (CN); Qi Huang, Chengdu (CN); Huiling Tai, Chengdu (CN); Zhen Yuan, Chengdu (CN); Yadong Jiang, Chengdu (CN)

(21) Appl. No.: 18/424,848

(22) Filed: Jan. 28, 2024

(30) Foreign Application Priority Data
Aug. 21, 2023 (CN) 202311050386.2

(51) Int. Cl. G01L 1/00

(52) U.S. Cl. CPC G01L 1/005

(57) ABSTRACT

An ion gradient power-generation stretching strain sensor and its preparation method, which relates to the technical field of flexible strain sensor and flexible wearable electronic technology, includes: latex pipes, an elastic line covered with a first hygroscopic sensitive material, two electrodes, and filter paper covered with a second hygroscopic sensitive material; wherein at both ends of the pipe, the filter paper is fixed inside and the corresponding electrodes of the elastic line at one end; the moisture absorption performance of the second hygroscopic sensitive material is better than the first hygroscopic sensitive material. The present invention realizes self-power supply of the sensor based on the ion gradient, does not require external power supply, and uses the elasticity line of the first hygroscopic sensitive material to achieve the strain detection, without consuming the material of the sensor itself and thus enhances life of the sensor.

### BACKGROUND OF THE PRESENT INVENTION

### Field of Invention

The present invention relates to the technical field of a flexible strain sensor and flexible wearable electronic technology, and more particularly to an ion gradient power-generation stretching strain sensor and its preparation method.

### Description of Related Arts

Flexible strain sensors have broad application prospects in the fields of health medicine, software robots, smart agriculture, smart home and other fields. At present, flexible strain sensors mainly include types of resistance, capacitance, voltage and friction. For example, a Chinese patent CN 115976828A discloses a flexible strain resistance sensor and its preparation method, wherein knitted fabrics composed of nylon fiber and amino spandex fibers are used as flexible substrates, flexible strain sensor is prepared by using conductive ink, wherein the conductive ink consists of graphite, conductive carbon black, modified epoxy resin, polyurethane, isoxone and methylbuitraxone mixture. Patent CN 115553755A discloses a dual-capacitor strain sensor and its preparation method, as well as the respiratory monitoring zone. The dual-capacitor strain sensor is layered structure, including the first loading layer, the first electrical layer, the first media layer, the second-conductor layer, the second medium, the third-guide layer, and the second installation in order layer. Patent CN 114894350 A discloses a high-performance piezoelectric strain sensor, including operating barrels, piezoelectric components, circuit boards and connecting rods. Patent CN 113624121 A discloses a fiber friction electrical strain sensor and its preparation method, which are the bottom layer of the fiber base, the working electrode layer and the packaging layer from the inside to the outside, wherein resistance and capacitive pressure sensors can realize static and dynamic strain perceptions, but external power supply is required to work. Although voltage and friction electrode strain sensors can directly generate voltage signals, and there is no need to apply incentive voltage during work, but due to the working principle, only dynamic strain can be perceived, and static strain monitoring needs cannot be met. Therefore, it is of great significance to develop power generation sensors that can detect dynamics and static strain at the same time.

### SUMMARY OF THE PRESENT INVENTION

The purpose of the present invention is to provide a ion gradient electrical stretching sensor and its preparation method for problems in the above-mentioned existing technologies, which can also meet the needs of static strain and dynamic strain detection at the same time.

The technical solutions used in the present invention are as follows:

An ion gradient power-generation stretching strain sensor, comprises: latex pipes, an elastic line covered with a first hygroscopic sensitive material, two electrodes, and filter paper covered with a second hygroscopic sensitive material; wherein at both ends of the pipe, the filter paper is fixed inside and the corresponding electrodes of the elastic line at one end; the moisture absorption performance of the second hygroscopic sensitive material is better than the first hygroscopic sensitive material.

Preferably, the two electrodes are set between the elastic line and the latex tube.

Preferably, one of the first hygroscopic is a carbon nanotubes or carbon black.

Preferably, the second hygroscopic is one member selected from lithium chloride, sodium algina or polycatic liquid.

Preferably, the material of the elastic line is polyester or nylon.

Preferably, the electrodes are made of one identical material selected from a group consisting of copper tape, aluminum tape, polyester electrical tape, zinc tape, magnesium tape, and magnesium tape.

Preferably, the ion gradient electrode stretching sensor has sensor current output under static strain and dynamic strain.

The present invention further provides a method for preparing the ion gradient power-generation stretching strain sensor, comprises steps of:
(1) preparing a saturated aquatic solution of a second hygroscopic sensitive material;
(2) soaking a clean filter paper in the saturated aqueous solution of the second hygroscopic sensitive material, after performing with ultrasound and dryness, placing it in the air to fully absorb the water molecules in the air, and obtaining the filter paper covered with the second hygroscopic sensitive material;
(3) preparing a water decentralized liquid of the first hygroscopic sensitive material;
(4) soaking the elastic line in the first hydrating sensitive material water decentralized liquid, after performing with ultrasound and drying, the elastic line with the first hygroscopic sensitive material is obtained;
(5) wrapping a filter paper with the second hygroscopic sensitive material in one end with the elastic line with the elastic line with the first hygroscopic sensitive material, and the electrode is introduced at the other end of the elastic line outside and the elastic line, so as to obtain the ion gradient power-generation stretching strain sensor.

Preferably, a concentration of water decentralized liquid of hydrating sensitive materials is at a range of 1-10 WT %.

The working principle of the ion gradient stretching sensor proposed by the present invention is: Suppose the two electrodes are the first electrodes and the second electrode, respectively, and the first electrode is fixed with filter paper; because in the air, the filter paper with a second hygroscopic sensitive material will adsorb a large amount of water molecules to saturated, so near the first electrode near the first electrode Formed a high-humidity area, a low-humidity area is formed near the second electrode. Because water molecules ionize will form hydrogen ions and hydroxide root ions, and then the ion gradient will be formed between the two electrodes; The regional orientation moves, and then outputs the voltage/current between the two electrodes to achieve self-power supply; through the stretching force line/latex pipe, the spacing of the first hygroscopic sensitive material covered on the elastic line is increased, resulting in an increase in internal resistance of the sensor large, the output of the sensing current is reduced, and the strain sensing is achieved.

In addition, because the filter paper with a second hygroscopic sensitive material is covered in the air, a large amount of water molecules will be adsorbed in the air, and the humidity of the paper will be higher than the environmental humidity during the strain sensing process. Therefore, the sensor will not be affected by the environmental humidity. Sensing stretching.

The beneficial effect of the invention is:

The ion gradient stretching sensor and its preparation method proposed by the present invention and its preparation method. The self-power supply of the sensor is realized based on the ion gradient, no external power supply is required. Meet the detection needs of static strain and dynamic strain. In addition, the material of the sensor itself will not be consumed during the sensor, and the sensor life will not be improved.

These and other objectives, features, and advantages of the present invention will become apparent from the following detailed description, the accompanying drawings, and the appended claims.

### BRIEF DESCRIPTION OF THE DRAWINGS

FIG. 1 is the three-dimensional transverse view of an ion gradient power-generation stretching strain sensor according to a preferred embodiment 1 of the present invention.

FIG. 2 is the left view of the ion gradient power-generation stretching strain sensor according to the preferred embodiment 1 of the present invention.

FIG. 3 is the cross-sectional diagram of the ion gradient power-generation stretching strain sensor according to the preferred embodiment 1 of the present invention.

FIG. 4 is the main view of the ion gradient power-generation stretching strain sensor according to the preferred embodiment 1 of the present invention.

FIG. 5 is a top view of the ion gradient power-generation stretching strain sensor according to the preferred embodiment 1 of the present invention.

FIG. 6 is a power generation principle diagram of the ion gradient power-generation stretching strain sensor according to the preferred embodiment 1 of the present invention.

FIG. 7 is a diagram showing a voltage curve of a continuously 5-hour power generation by the ion gradient power-generation stretching strain sensor according to the preferred embodiment 1 of the present invention.

FIG. 8 is a diagram showing a response/recovery curve of the ion gradient power-generation stretching strain sensor according to the preferred embodiment 1 of the present invention under 10% stretching.

FIG. 9 is a diagram showing the current response of the ion gradient power-generation stretching strain sensor according to the preferred embodiment 1 of the present invention at different stretching strains.

FIG. 10 is a diagram showing a response/recovery curve of the ion gradient power-generation stretching strain sensor according to the preferred embodiment 1 of the present invention while being applied in respiratory monitoring of a human body.

### NUMBERS OF ELEMENTS IN THE DRAWINGS

1—elastic line covered with a first hygroscopic sensitive material; 2—filter paper covered with a second hygroscopic sensitive material; 3—first electrode, 4—latex tube; 5—second electrode.

### DETAILED DESCRIPTION OF THE PREFERRED EMBODIMENT

In order to make the purpose, technical solutions and advantages of the present invention more and more clear, the following combined with the attached drawings and the embodiment to further explain the present invention in detail. It should be understood that the specific embodiments described here are only used to explain the present invention and do not limit the present invention.

### Embodiment 1

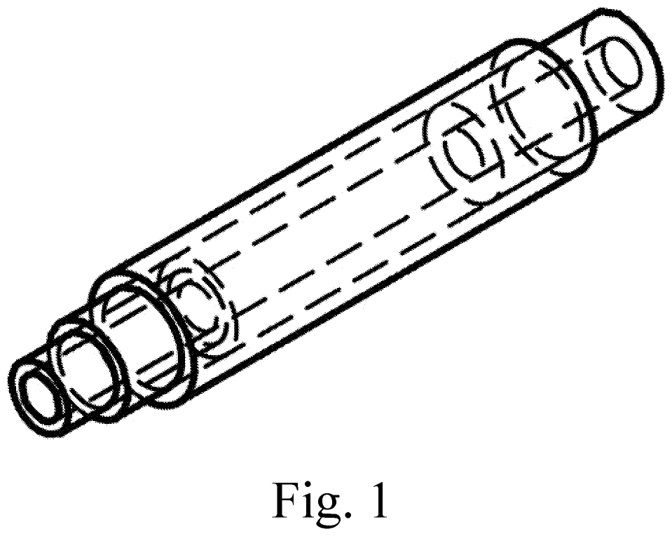

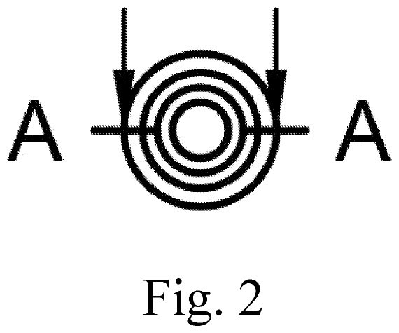

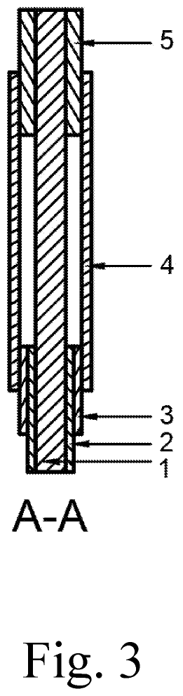

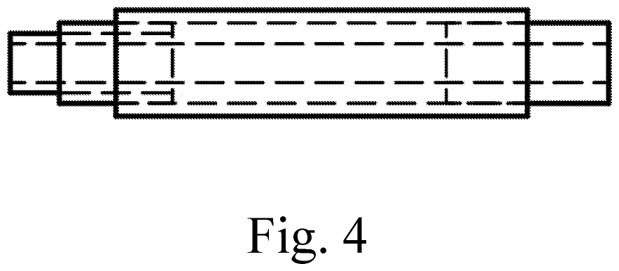

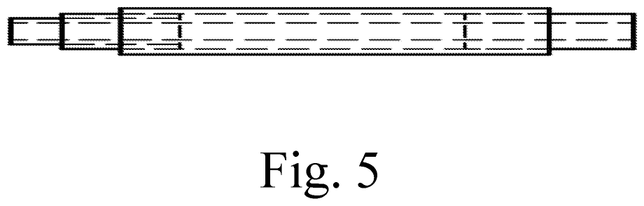

This embodiment provides an ion gradient electrode stretch stretching sensor. The structure is shown in FIGS. 1-5, comprising a latex pipes 4, an elastic line 1 covered with a first moisture-absorbent material 1, a first electrode 3, a second electrode 5, and a filter paper 2 covered with a second hygroscopic sensitive material.
wherein the elastic line 1 passes through the latex pipe 4, the first electrode 3 and the second electrode 5 are fixed on the elastic line 1/latex pipe 4 ends, and the elastic line 1 and latex pipe 4 are located; The interior of the one-electrode 3 and the outside of the elastic line 1 of one end; the moisture absorption performance of the second hygroscopic sensitive material is better than the first hygroscopic sensitive material. The example of this embodiment is specifically used as the second hygroscopic sensitive material, and the carbon nanotubes are the first hygroscopic water absorption. Sensitive materials; the material of elastic line 1 is polyester, and the first electrode 3 and the second electrode 5 uses copper tape.

The method of preparing ion gradient electrocarcation sensor in this embodiment includes the following steps of:
(1) Configure LICL saturated water solution;
(2) Soak the clean filter paper in the LICL saturated aqueous solution. After 15 min and dry, place it in the air for 24 h to fully absorb the water molecules in the air. 2;
(3) Configure 10 WT % of carbon nanotimal pipe water decentralization liquid;
(4) Soak the elastic line in the carbon nanotuba decentralized liquid. After 15 min and dry, the elastic line is covered with the first hygroscopic sensitive material 1;
(5) Filter paper 2 packages covering the second hygroscopic sensitive material are wrapped in one end of the elastic line 1 covered with the first hygroscopic sensitive material, and the first electrode 3 and the other end of the elastic line 1 are led to the outside of the filter paper 2 and the elastic line 1 end. The second electrode 5, after the latex pipe 4 is packaged, obtained the ion gradient electrocales of stretching the strain sensor.

In this embodiment, the filter paper 2 with a second hygroscopic sensitive material 2 will adsorb a large amount of water molecules in the air to saturated in the air. Therefore, the high humidity area is formed near the first electrode 3, and the low-humidity area is formed near the second electrode 5. Then form an ion gradient between the two electrodes; the hydrogen ions formed by the ionization of water molecules are directed from the high humidity area in the sensor to the low-humidity area, and then the output voltage/current between the two electrodes is Line 1/latex pipe 4, the spacing of the first hygroscopic sensitive material covered on the elastic line 1 increases, leading to an increase in internal resistance of the sensor, a decrease in the output of the sensor current, and achieving the strain sensing.

In addition, because the filter paper with the second hygroscopic sensitive material 2 will adsorb a large amount of water molecules in the air to saturate, the humidity of the filter paper will be higher than the environmental humidity during the strain sensing process, so the sensor will not be affected by the environmental humidity. Sensing stretching.

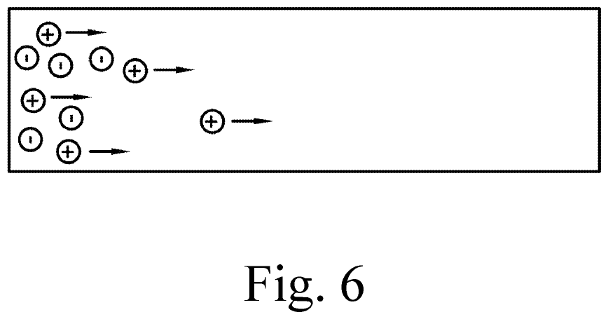

FIG. 6 shows the power generation principle diagram of the ion gradient stretching the strain sensor. After the filter paper with excellent hygroscopic properties is adsorbed, water molecular ionization forms a hydrogen ion with a positive charge and a hydrogen-based ion with negative charges. The hydrogen ion with a positive charge moves to the low-humidity area. Essence

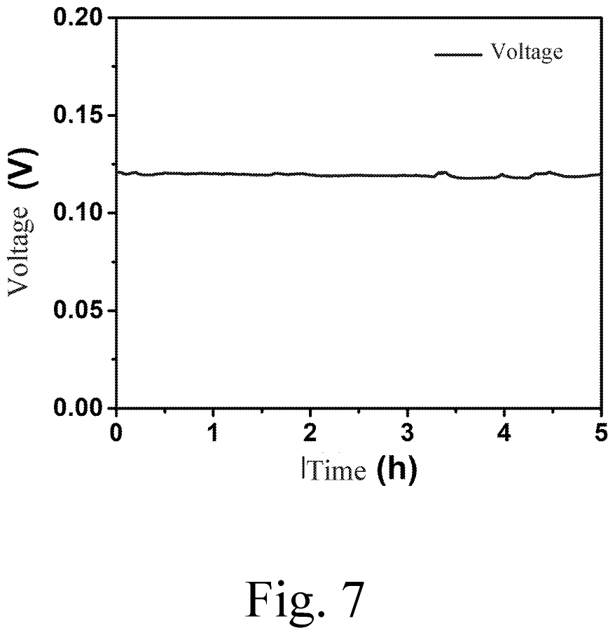

FIG. 7 shows the voltage curve of the sensor for 5 h in a continuous 5 h, indicating that it can stabilize the output voltage for a long time to achieve stable self-power supply.

This embodiment defines the current of the sensor as ΔI/i0, where I0 is the output current of the sensor when not subject to the strain, and Al is the current change when the sensor is affected by the strain. Define the sensitivity of the sensor gf=Δ (Δi/i0)/Δ(ε). Among them, ε is the stretch strain of the sensor, and Δ (⋅) means a small increment.

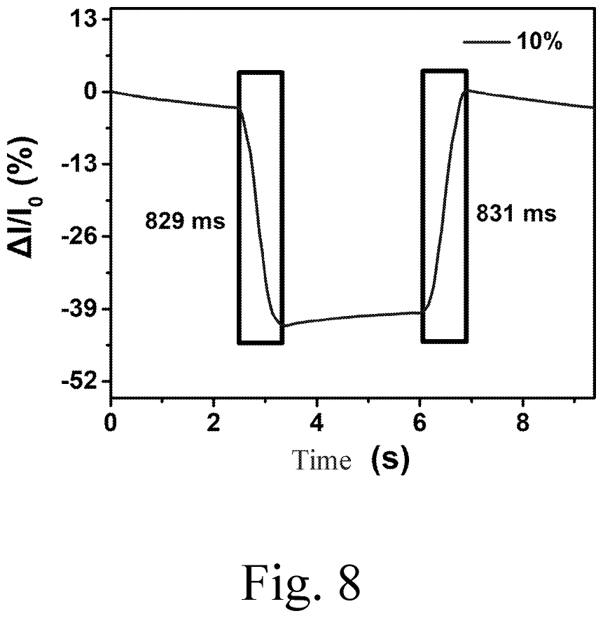

FIG. 8 shows the response/recovery curve of the sensor at 10% stretching. Within the time range of 829 ms shown in the left side of the figure, the stretching strain of the sensor is gradually increasing, and its current response gradually decreases, indicating that it has dynamic strain detection capabilities. After the 829 MS, the stretching strain of the sensor remains unchanged, and its current response has also stabilized, proving that it has static stretching strain detection capabilities. Within the time range of the 831 ms shown in the right side of the figure, the stretching strain of the sensor gradually approaches 0, and its current response gradually approaches 0. It can be seen that the sensors proposed by these embodiments have sensor current output under static strain and dynamic strain, which achieves accurate detection of static strain and dynamic strain.

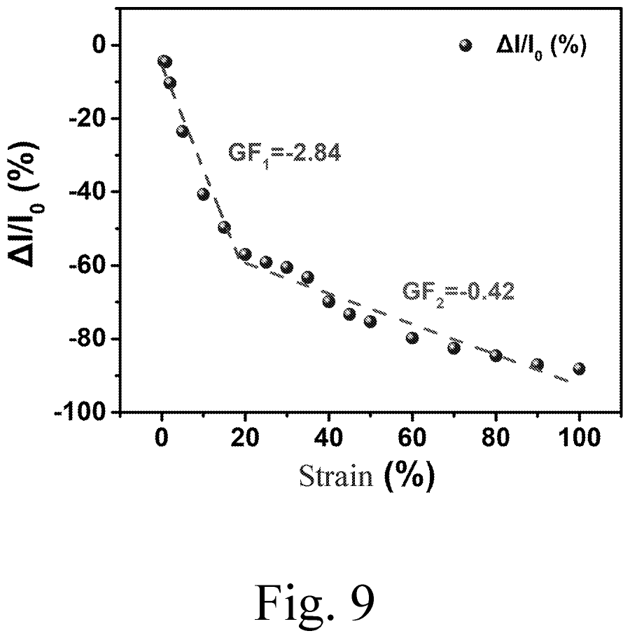

FIG. 9 shows the current response of the sensor at different stretching response. Within 0.5% to 20% of the stretching range, the strain sensitivity of the sensor is −2.84; within the range of 20%-100% stretching strain range, the strain sensitivity of the sensor is −0.42.

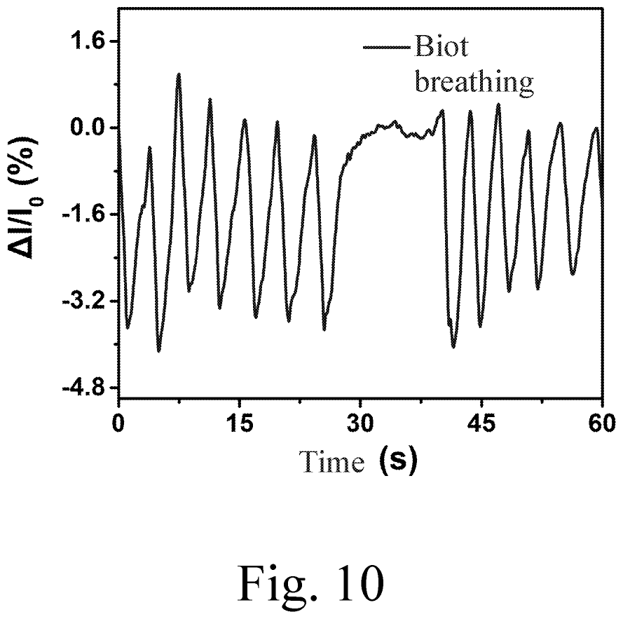

FIG. 10 shows the response/recovery curve of the sensor's respiratory monitoring. Fixed the sensor to the abdomen of the human body. The protruding of the abdomen during breath can cause the sensor to be stretched and strain, and the stretching strain of the sensor after the abdomen is gradually approaching 0. Therefore, a cycle of the waveform corresponds to a respiration process of the person. When a person stops breathing (such as 27 S −40 S), the output waveform of the sensor will no longer have a periodic rise and decrease, indicating that the sensor has static/dynamic strain detection capabilities.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An ion gradient power-generation stretching strain sensor, comprising: latex pipes, an elastic line covered with a first hygroscopic sensitive material, two electrodes, and filter paper covered with a second hygroscopic sensitive material; wherein at both ends of the pipe, the filter paper is fixed inside and the corresponding electrodes of the elastic line at one end; the moisture absorption performance of the second hygroscopic sensitive material is better than the first hygroscopic sensitive material.

2. The ion gradient power-generation stretching strain sensor, as recited in claim 1, wherein the two electrodes are set between the elastic line and the latex tube.

3. The ion gradient power-generation stretching strain sensor, as recited in claim 1, wherein one of the first hygroscopic is a carbon nanotubes or carbon black.

4. The ion gradient power-generation stretching strain sensor, as recited in claim 1, wherein the second hygroscopic is one member selected from lithium chloride, sodium algina or polycatic liquid.

5. The ion gradient power-generation stretching strain sensor, as recited in claim 1, wherein the material of the elastic line is polyester or nylon.

6. The ion gradient power-generation stretching strain sensor, as recited in claim 1, wherein the electrodes are made of one identical material selected from a group consisting of copper tape, aluminum tape, polyester electrical tape, zinc tape, magnesium tape, and magnesium tape.

7. A method for preparing the ion gradient power-generation stretching strain sensor, as recited in claim 1, comprising steps of:
(1) preparing a saturated aquatic solution of a second hygroscopic sensitive material;
(2) soaking a clean filter paper in the saturated aqueous solution of the second hygroscopic sensitive material, after performing with ultrasound and dryness, placing it in the air to fully absorb the water molecules in the air, and obtaining the filter paper covered with the second hygroscopic sensitive material;
(3) preparing a water decentralized liquid of the first hygroscopic sensitive material;
(4) soaking the elastic line in the first hydrating sensitive material water decentralized liquid, after performing with ultrasound and drying, the elastic line with the first hygroscopic sensitive material is obtained;
(5) wrapping a filter paper with the second hygroscopic sensitive material in one end with the elastic line with the elastic line with the first hygroscopic sensitive material, and the electrode is introduced at the other end of the elastic line outside and the elastic line, so as to obtain the ion gradient power-generation stretching strain sensor.

8. The preparing method, as recited in claim 7, wherein a concentration of water decentralized liquid of hydrating sensitive materials is at a range of 1-10 WT %.
